(19) United States
(12) Patent Application Publication
(10) Pub. No.: US 2021/0167565 A1
(43) Pub. Date: Jun. 3, 2021

(54) ELECTRICAL PLUG

(71) Applicant: DONGSAN ELECTRONICS CO., LTD, Gimhae-si (KR)

(72) Inventor: Dae Ho LEE, Gimhae-si (KR)

(73) Assignee: DONGSAN ELECTRONICS CO., LTD, Gimhae-si (KR)

(21) Appl. No.: 16/942,465

(22) Filed: Jul. 29, 2020

Related U.S. Application Data
(63) Continuation of application No. PCT/KR2019/016968, filed on Dec. 4, 2019.

(30) Foreign Application Priority Data
Dec. 2, 2019 (KR) 10-2019-0158638

(51) Int. Cl. H01R 31/06; H01R 27/00

(52) U.S. Cl. CPC H01R 31/06; H01R 2103/00; H01R 27/00

(57) ABSTRACT

A plug for combined use and applicable to a variety of electrical outlets having different forms. The plug includes a body plug portion, a connection plug portion attached to or detached from one side of the body plug portion, a push portion fastened to a lateral surface of the body plug portion, a body plug portion body portion, and a body plug portion cover portion which covers the body plug portion body portion. The body plug portion body portion includes a connection plug portion body portion first mounting portion on which the connection plug portion body portion of the connection plug portion is mounted. The connection plug portion body portion first mounting portion includes a first base plate, a first space portion formed above the first base plate, and a fastening hole which is located in an area of the first space portion and passes through the first base plate.

### CROSS-REFERENCE TO RELATED APPLICATIONS

The present application is a continuation of International Patent Application No. PCT/KR2019/016968, filed Dec. 4, 2019, which is based upon and claims the benefit of priority to Korean Patent Application No. 10-2019-0158638, filed on Dec. 2, 2019. The disclosures of the above-listed applications are hereby incorporated by reference herein in their entirety.

### TECHNICAL FIELD

The present invention relates to an electrical plug, and more particularly, to an electrical plug which is applicable to a variety of electrical outlets having different forms.

### BACKGROUND ART

In general, a plug, which is connected to an electrical outlet to provide power, is provided at an end of a power supply of an electrical device or electrical product.

A shape of such plugs varies to match power such as 110 V and 220 V used in general homes. Generally, a plug for power of 110 V includes bar-shaped connection members, and a plug for power of 220 V includes cylindrical connection members.

As described above, since power of 110 V or 220 V is supplied to households, in order to use an electrical device or electrical product which is released while being standardized with both voltages, an adapter is mounted on a plug for one type of power to use with another type of power.

An example thereof is shown in FIG. 1.

FIG. 1 is a perspective view illustrating components of a conventional separable plug used for both 110 V and 220 V.

As households in which 220 V is used increase, as shown in the drawing, an existing plug is used for 110 V while an adapter 20 for 110 V is mounted on a plug 10 for 220 V to which an electrical wire is connected. That is, the plug 10 of 220 V which has cylindrical connection members 12 is connected, as it is, to an electrical outlet (not shown) for 220 V, and the adapter 20 for 110 V is mounted on a front part of the plug 10 and bar-shaped connection members 22 are inserted into an electrical outlet for 110 V.

Here, the cylindrical connection members 12 of the plug 10 are electrically connected to the bar-shaped connection members 22 of the adapter 20 by inserting the cylindrical connection members 12 into insertion holes 24 formed in a rear part of the adapter 20.

Universally, connection members for 220 V have a cylindrical shape, and connection members for 110 V are formed as bar-shaped panel members.

On the other hand, there is a product used by mounting an adapter for 220 V on a plug for 110 V to which an electrical wire is connected.

In an existing separable plug as described above, since it is necessary to mount or separate an adapter when 110 V or 220 V is exchanged, it is inconvenient to use the plug. Also, since it is necessary to store the detached and separated adapter, the adapter may be easily lost.

In addition, since an adapter is mounted on a front of a plug, the plug protrudes significantly from a wall structure where an electrical outlet is present such that the plug catches onto people passing therethrough. Accordingly, the plug is frequently detached therefrom and it is difficult to connect the plug to the electrical outlet in a narrow space.

Also, since the plug and the adapter are manufactured as two components, manufacturing costs increase.

### DISCLOSURE

### Technical Problem

The present invention is directed to providing an electrical plug which is applicable to a variety of electrical outlets having different forms.

Objects of the present invention are not limited to the above-stated objects and other unstated objects of the present invention will be understood by those skilled in the art from the following description.

### Technical Solution

One aspect of the present invention provides a connection plug including a connection plug body portion, a first pin portion located on one side of the connection plug body portion, a second pin portion located on the other side of the connection plug body portion, a first slit portion located on a first side surface of the connection plug body portion, and a second slit portion located on a second side surface of the connection plug body portion. Here, the connection plug body portion includes a connection plug first body portion and a connection plug second body portion fastened to the connection plug first body portion. Also, the connection plug body portion includes a first fastening groove located in a certain area of the connection plug first body portion and a second fastening groove located in a certain area of the connection plug second body portion.

The first fastening groove may include a 1-1 fastening groove located adjacent to the first pin portion and a 1-2 fastening groove disposed to be spaced at a certain interval apart from the 1-1 fastening groove and located to be adjacent to the second pin portion, and the second fastening groove may include a 2-1 fastening groove located to be adjacent to the first pin portion and a 2-2 fastening groove disposed to be spaced at a certain interval apart from the 2-1 fastening groove and located to be adjacent to the second pin portion. Also, the first slit portion may include a 1-1 slit located to be adjacent to the first pin portion and a 1-2 slit located to be adjacent to the second pin portion, and the second slit portion may include a 2-1 slit located to be adjacent to the first pin portion and a 2-2 slit located to be adjacent to the second pin portion.

Another aspect of the present invention provides a plug including a body plug portion, a connection plug portion detachably attached to one side of the body plug portion, and a push portion fastened to a lateral surface of the body plug portion. Here, the body plug portion includes a body plug portion body portion and a body plug portion cover portion which covers the body plug portion body portion. The body plug portion body portion includes a connection plug portion body portion first mounting portion on which the connection plug portion body portion of the connection plug portion is mounted, and the connection plug portion body portion first mounting portion includes a first base plate, a first space portion formed above the first base plate, and a fastening hole which is located in an area of the first space portion and passes through the first base plate.

The connection plug may include a connection plug body portion, a first pin portion located on one side of the connection plug body portion, a second pin portion located on the other side of the connection plug body portion, a first slit portion located on a first side surface of the connection plug body portion, and a second slit portion located on a second side surface of the connection plug body portion. Also, the connection plug body portion may include a connection plug first body portion and a connection plug second body portion fastened to the connection plug first body portion and may include a first fastening groove located in a certain area of the connection plug first body portion and a second fastening groove located in a certain area of the connection plug second body portion.

The first fastening groove may include a 1-1 fastening groove located to be adjacent to the first pin portion and a 1-2 fastening groove disposed to be spaced at a certain interval apart from the 1-1 fastening groove and located to be adjacent to the second pin portion, and the second fastening groove may include a 2-1 fastening groove located to be adjacent to the first pin portion and a 2-2 fastening groove disposed to be spaced at a certain interval apart from the 2-1 fastening groove and located to be adjacent to the second pin portion. Also, the first slit portion may include a 1-1 slit located to be adjacent to the first pin portion and a 1-2 slit located to be adjacent to the second pin portion, and the second slit portion may include a 2-1 slit located to be adjacent to the first pin portion and a 2-2 slit located to be adjacent to the second pin portion.

While the connection plug portion is fastened to one side of the body plug portion, the fastening hole and the first fastening groove may be fastened using a fixing device. While the connection plug portion is fastened to the one side of the body plug portion, the fastening hole and the second fastening groove may be fastened using the fixing means.

When the first pin portion is inserted into the body plug portion, the fastening hole and the 1-1 fastening groove may be located in corresponding areas or the fastening hole and the 2-1 fastening groove may be located in corresponding areas. Also, when the second pin portion is inserted into the body plug portion, the fastening hole and the 1-2 fastening groove may be located in corresponding areas or the fastening hole and the 2-2 fastening groove may be located in corresponding areas.

The push portion may include a first push portion fastened to a first side of the body plug portion body portion and a second push portion fastened to a second side of the body plug portion body portion. The connection plug portion body portion first mounting portion may include a first push portion first fastening portion located on a first side of the first base plate and a second push portion first fastening portion located on a second side of the first base plate. The first push portion may include a first push portion body portion, a first push plate located on an outer side surface of the first push portion body portion, a first concave portion located on a rear surface and a front surface of the first push portion body portion, a first holding protruding portion protruding from an inner side surface of the first push portion body portion, an elastic body first support portion protruding from a bottom surface of the first push portion body portion, and a first elastic body inserted into the elastic body first support portion. The second push portion may include a second push portion body portion, a second push plate located on an outer side surface of the second push portion body portion, a second concave portion located on a rear surface and a front surface of the second push portion body portion, a second holding protruding portion protruding from an inner side surface of the second push portion body portion, an elastic body second support portion protruding from a bottom surface of the second push portion body portion, and a second elastic body inserted into the elastic body second support portion. Also, the first concave portion may include a 1-1 concave portion located on the rear surface of the first push portion body portion and a 1-2 concave portion located on the front surface of the first push portion body portion, and the second concave portion may include a 2-1 concave portion located on the rear surface of the second push portion body portion and a 2-2 concave portion located on the front surface of the second push portion body portion.

When the first pin portion is inserted into the body plug portion, the first holding protruding portion may be inserted into the 1-1 slit and the second holding protruding portion may be inserted into the 2-1 slit or the first holding protruding portion may be inserted into the 2-1 slit and the second holding protruding portion may be inserted into the 1-1 slit. Also, when the second pin portion is inserted into the body plug portion, the first holding protruding portion may be inserted into the 1-2 slit and the second holding protruding portion may be inserted into the 2-2 slit or the first holding protruding portion may be inserted into the 2-2 slit and the second holding protruding portion may be inserted into the 1-2 slit.

The body plug portion body portion may include a connection plug portion pin portion first connection portion located continuously with the connection plug portion body portion first mounting portion. The connection plug portion pin portion first connection portion may include a pin portion connection terminal. The pin portion connection terminal may include a pin portion first connection terminal and a pin portion second connection terminal disposed to be spaced at a certain interval apart from the pin portion first connection terminal. The pin portion first connection terminal may include a first base terminal, a first fastening terminal extending from a side surface of one side of the first base terminal in a longitudinal direction, a first pin portion first insertion portion located in a 1-1 area above the first base terminal, and a second pin portion first insertion portion located in a 1-2 area above the first base terminal to be adjacent to the first pin portion first insertion portion. The first pin portion first insertion portion may include a 1-1 plate extending from a side surface of the other side of the first base terminal in the longitudinal direction and located in a state of being bent from the first base terminal at a certain angle, and the second pin portion first insertion portion may include a 1-2 plate extending from a side surface of one side of the first base terminal in a width direction and located in a state of being bent from the first base terminal at a certain angle and a 1-3 plate which is disposed to face the 1-2 plate, extends from a side surface of the other side of the first base terminal in the width direction, and is located in a state of being bent from the first base terminal at a certain angle. The first pin portion first insertion portion may include a first pin portion first insertion space located between the 1-2 plate, a side surface of the 1-3 plate, and a plate surface of the 1-1 plate, and the second pin portion first insertion portion may include a second pin portion first insertion space located between a plate surface of the 1-2 plate and a plate surface of the 1-3 plate. The pin portion second connection terminal may include a second base terminal, a second fastening terminal extending from a side surface of one side of the second base terminal in a longitudinal direction, a first pin portion second insertion portion located in a 2-1 area above the second base terminal, and a second pin portion second insertion portion located in a 2-2 area above the second base terminal to be adjacent to the first pin portion second insertion portion. The first pin portion second insertion portion may include a 2-1 plate extending from a side surface of the other side of the second base terminal in the longitudinal direction and located in a state of being bent from the second base terminal at a certain angle, and the second pin portion second insertion portion may include a 2-2 plate extending from a side surface of one side of the second base terminal in a width direction and located in a state of being bent from the second base terminal at a certain angle and a 2-3 plate which is disposed to face the 2-2 plate, extends from a side surface of the other side of the second base terminal in the width direction, and is located in a state of being bent from the second base terminal at a certain angle. Also, the first pin portion second insertion portion may include a first pin portion second insertion space located between the 2-2 plate, a side surface of the 2-3 plate, and a plate surface of the 2-1 plate, and the second pin portion second insertion portion may include a second pin portion second insertion space located between a plate surface of the 2-2 plate and a plate surface of the 2-3 plate.

### Advantageous Effects

According to the present invention, since whether a second pin portion of a connection plug is inserted into an electrical outlet or a first pin portion of the connection plug is inserted into the electrical outlet varies depending on whether the first pin portion is inserted into a body plug portion or the second pin portion is inserted into the body plug portion, a plug for combined use which is applicable to a variety of electrical outlets having different forms may be provided.

### BRIEF DESCRIPTION OF DRAWINGS

FIG. 1 is a perspective view illustrating components of a conventional separable plug used for both 110 V and 220 V.

FIG. 2 is a perspective view illustrating an electrical plug according to the present invention.

FIG. 3 is a side view illustrating the electrical plug according to the present invention.

FIG. 4 is a front view illustrating the electrical plug according to the present invention.

FIG. 5 is a perspective view illustrating a fastening state of a body plug portion body portion and a connection plug portion according to the present invention.

FIG. 6 is a plane view illustrating the fastening state of the body plug portion body portion and the connection plug portion.

FIG. 7 is a perspective view illustrating the body plug portion body portion according to the present invention.

FIG. 8 is a side view illustrating body plug portion body portion according to the present invention.

FIG. 9 is a plane view illustrating the body plug portion body portion according to the present invention.

FIG. 10 is a front view illustrating the body plug portion body portion according to the present invention.

FIG. 11 is a perspective view illustrating a body plug portion cover portion according to the present invention.

FIG. 12 is a plane view illustrating the body plug portion cover portion according to the present invention.

FIG. 13 is a side view illustrating the body plug portion cover portion according to the present invention.

FIG. 14 is a perspective view illustrating a connection plug according to the present invention.

FIG. 15 is a front view illustrating the connection plug according to the present invention.

FIG. 16 is a rear view illustrating the connection plug according to the present invention.

FIG. 17 is a side view illustrating the connection plug according to the present invention.

FIG. 18 is a perspective view illustrating the connection plug according to the present invention excluding a first body portion.

FIG. 19 is a front view illustrating the connection plug according to the present invention excluding the first body portion.

FIG. 20 is a perspective view illustrating a push portion according to the present invention.

FIG. 21 is a bottom view illustrating the push portion according to the present invention.

FIG. 22 is a front view illustrating the push portion according to the present invention.

FIG. 23 is a plane view illustrating the push portion according to the present invention.

FIG. 24 is a perspective view illustrating a pin portion connection terminal according to the present invention.

FIG. 25 is a plane view illustrating the pin portion connection terminal according to the present invention.

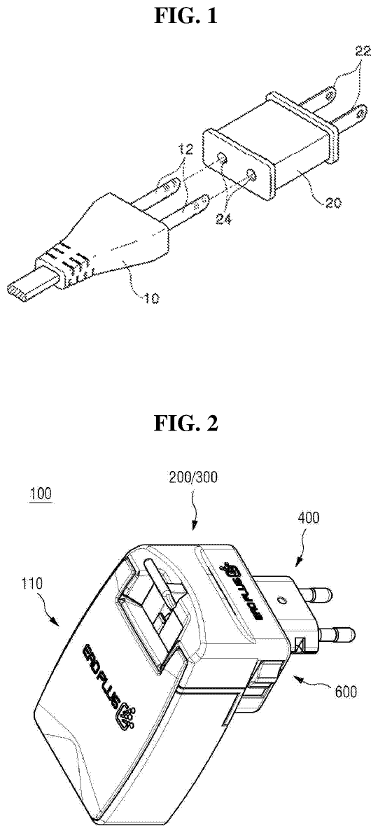

### DETAILED DESCRIPTION

The advantages and features of the present invention and a method of achieving the same will become apparent with reference to the attached drawings and following embodiments which will be described below in detail. However, the present invention is not limited to the embodiments which will be described below and may be implemented as a variety of different shapes. It should be noted that the embodiments are provided merely for completing the disclosure of the present invention and allowing one of ordinary skill in the art to understand the complete scope of the present invention and the present invention will be defined by the claims.

Detailed content for implementing the present invention will be described in detail with reference to the attached drawings. Regardless of the drawings, like reference numerals refer to like elements, and the terms “and/or” include any and all combinations of one or a plurality of stated items.

Although the terms such as first, second, and the like are used for describing a variety of elements, the elements are not limited to the terms. These terms are merely used for distinguishing one element from another element. Accordingly, a first element stated hereafter may be a second element within the technical concept of the present invention.

The terms used herein are intended to describe the embodiments but not intended to restrict the present invention. In the specification, unless stated otherwise particularly, singular forms include plural forms. The terms such as “comprises” and/or “comprising” used herein do not exclude the presence or addition of one or more elements in addition to stated elements.

Unless defined otherwise, the terms (including technical and scientific terms) used herein may be used as meanings capable of being commonly understood by one of ordinary skill in the art. Also, terms defined in generally used dictionaries, unless particularly defined, are not to be ideally or excessively construed.

The terms “below,” “beneath,” “lower,” “above,” “upper,” and the like which are spatially relative terms may be used to easily describe a relationship between one element and other elements as shown in the drawings. The spatially relative terms should be understood as terms including mutually different directions of elements when the elements are used or operate in addition to directions shown in the drawings. For example, when elements shown in the drawings are turned upside down, one element described as being “below” or “beneath” another element may be placed “above” the other element. Accordingly, “below” which is an exemplary term may include both downward and upward directions. An element may be oriented in a different direction such that the spatially relative terms may be construed according to orientation.

Hereinafter, exemplary embodiments of the present invention will be described in detail with reference to the attached drawings.

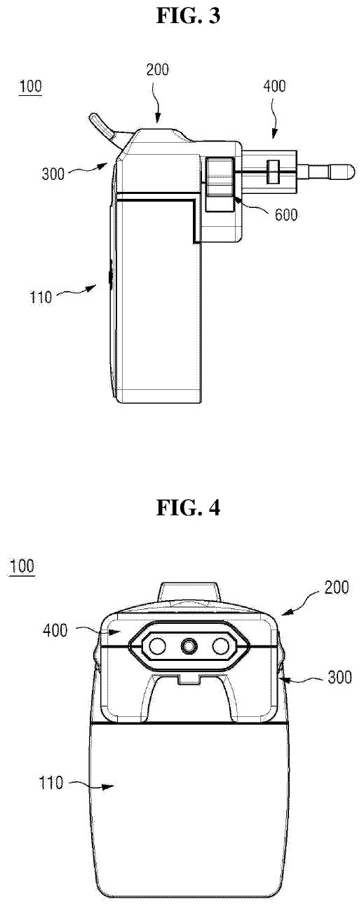

FIG. 2 is a perspective view illustrating an electrical plug according to the present invention, FIG. 3 is a side view illustrating the electrical plug according to the present invention, and FIG. 4 is a front view illustrating the electrical plug according to the present invention.

Referring to FIGS. 2 to 4, an electrical plug 100 (hereinafter, referred to as “plug”) according to the present invention includes a body plug portion 200 and 300 and a connection plug portion 400 attached to or detached from one side of the body plug portion 200 and 300.

Also, the plug 100 according to the present invention may include an auxiliary plug portion 110 located on the other side of the body plug portion 200 and 300.

In the auxiliary plug portion 110, components such as a variety of wires or a circuit board may be inserted. For example, a wire or a circuit board which is connected to a pin of the connection plug portion which will be described below may be located in the auxiliary plug portion 110. However, the present invention is not intended to restrict whether the auxiliary plug portion 110 is present or not.

Subsequently, referring to FIGS. 2 to 4, the body plug portion 200 and 300 of the plug 100 according to the present invention includes a body plug portion body portion 300 and a body plug portion cover portion 200 which covers the body plug portion body portion 300.

Also, the plug 100 according to the present invention includes a push portion 600 fastened to a side of the body plug portion body portion 300.

That is, the body plug portion cover portion 200 may be fastened to or separated from the body plug portion body portion 300. As described below, while the push portion 600 is fastened to the side of the body plug portion body portion 300, the body plug portion cover portion 200 may be fastened to the body plug portion body portion 300 so as to prevent the push portion 600 from being separated from the body plug portion body portion 300.

Accordingly, it may be defined that the push portion 600 is fastened to the side of the body plug portion body portion 300 and a side of the body plug portion cover portion 200.

Meanwhile, the body plug portion cover portion 200 may be fastened to the body plug portion body portion 300 using a well-known fastening means, for example, screw coupling, bolt-and-nut coupling, and the like. The present invention is not intended to restrict the fastening means for the body plug portion cover portion 200 and the body plug portion body portion 300.

Hereinafter, the plug according to the present invention will be described in detail.

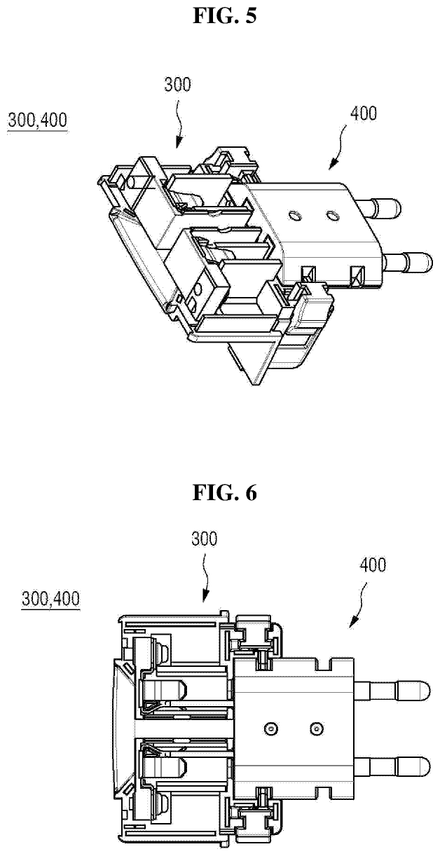

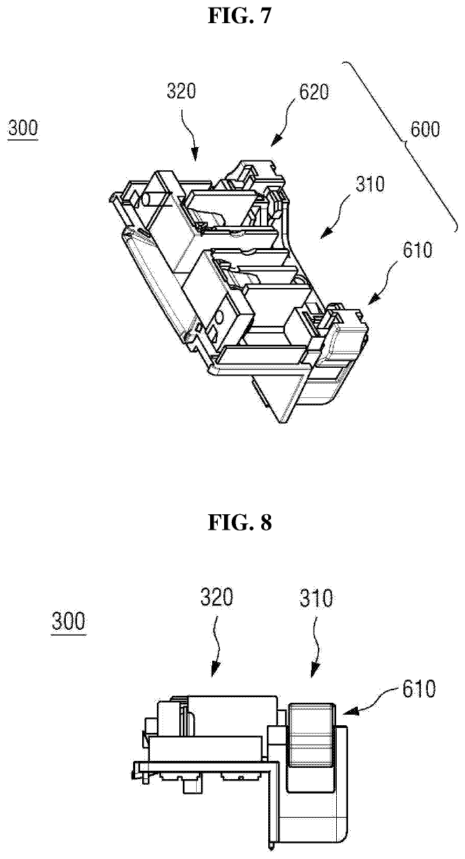

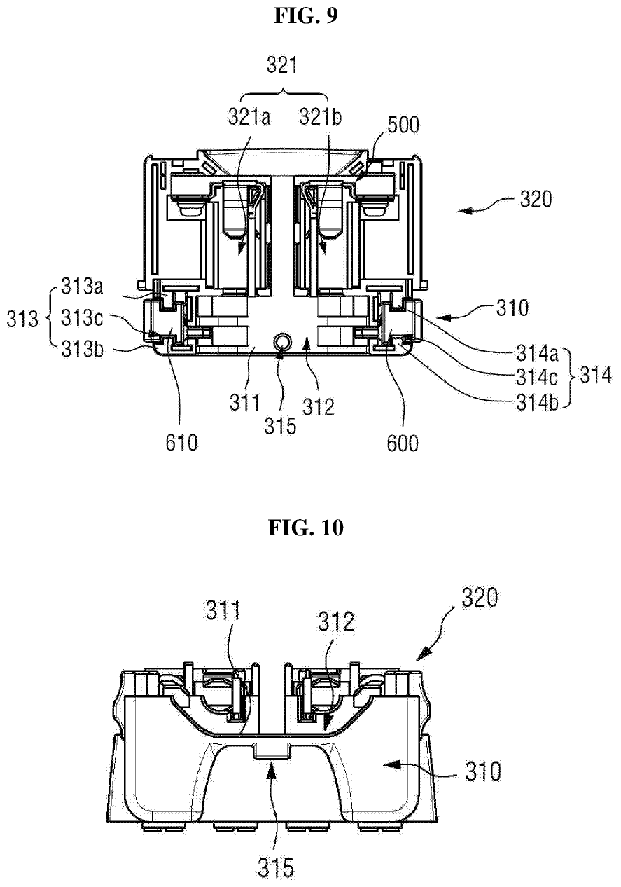

FIG. 5 is a perspective view illustrating a fastening state of the body plug portion body portion and the connection plug portion according to the present invention, FIG. 6 is a plane view illustrating the fastening state of the body plug portion body portion and the connection plug portion, FIG. 7 is a perspective view illustrating the body plug portion body portion according to the present invention, FIG. 8 is a side view illustrating the body plug portion body portion according to the present invention, FIG. 9 is a plane view illustrating the body plug portion body portion according to the present invention, and FIG. 10 is a front view illustrating the body plug portion body portion according to the present invention.

That is, in FIGS. 5 and 6, for convenience of description, the plug according to the present invention, excluding the body plug portion cover portion and the auxiliary plug portion, is shown. In FIGS. 7 to 10, the plug according to the present invention, excluding the body plug portion cover portion, the auxiliary plug portion, and the connection plug, is shown.

Referring to FIGS. 5 to 10, the body plug portion body portion 300 includes a connection plug portion body portion first mounting portion 310, on which the connection plug portion body portion of the connection plug portion 400 is mounted, and a connection plug portion pin portion first connection portion 320 located consecutively with the connection plug portion body portion first mounting portion 310.

That is, as described below, the connection plug portion 400 according to the present invention includes a connection plug portion body portion 410 and 420 (refer to FIG. 14) and includes a first pin portion 450 (refer to FIG. 14) located on one side of the connection plug portion body portion 410 and 420 and a second pin portion 460 (refer to FIG. 14) located on the other side of the connection plug portion body portion 410 and 420. The connection plug portion body portion 410 and 420 is located on the connection plug portion body portion first mounting portion 310, and the first pin portion 450 or the second pin portion 460 may be connected to the connection plug portion pin portion first connection portion 320 to be electrically connected.

Subsequently, referring to FIGS. 5 to 10, the connection plug portion body portion first mounting portion 310 includes a first base plate 311 and a first space portion 312 formed above the first base plate 311.

Here, the connection plug portion body portion 410 and 420 of the connection plug portion 400 may be mounted on the first space portion 312.

Meanwhile, as described above, the plug 100 according to the present invention includes the push portion 600 fastened to the side of the body plug portion body portion 300, and the push portion 600 includes a first push portion 610 fastened to a first side of the body plug portion body portion 300 and a second push portion 620 fastened to a second side of the body plug portion body portion 300.

Here, the connection plug portion body portion first mounting portion 310 includes a first push portion first fastening portion 313 located on a first side of the first base plate 311 and a second push portion first fastening portion 314 located on a second side of the first base plate 311. That is, the first push portion 610 is fastened to the first push portion first fastening portion 313, and the second push portion 620 is fastened to the second push portion first fastening portion 314.

In more detail, the first push portion first fastening portion 313 includes a 1-1 protruding portion 313a, a 1-2 protruding portion 313b disposed to be spaced at a certain interval apart from the 1-1 protruding portion 313a, and a 1-1 gap 313c according to the interval between the 1-1 protruding portion 313a and the 1-2 protruding portion 313b. The second push portion first fastening portion 314 includes a 2-1 protruding portion 314a, a 2-2 protruding portion 314b disposed to be spaced at a certain interval from the 2-1 protruding portion 314a, and a 2-1 gap 314c according to the interval between the 2-1 protruding portion 314a and the 2-2 protruding portion 314b.

Fastening between the first push portion and the second push portion through the first push portion first fastening portion 313 and the second push portion first fastening portion 314 will be described below.

Also, the connection plug portion body portion first mounting portion 310 includes a fastening hole 315 which is located in an area of the first space portion 312 of the first base plate 311 and passes through the first base plate 311.

The fastening hole 315 is for fixing the connection plug portion 400, which will be described below.

Subsequently, referring to FIGS. 5 to 10, the connection plug portion pin portion first connection portion 320 includes a pin portion connection terminal 500 and a pin portion connection terminal first disposition portion 321.

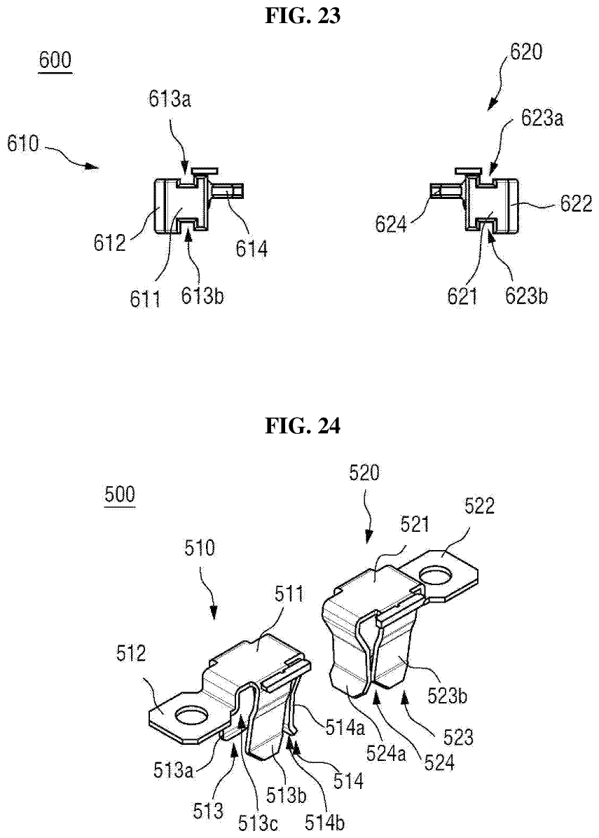

Here, as described below, the pin portion connection terminal 500 includes a pin portion first connection terminal 510 (refer to FIG. 24) and a pin portion second connection terminal 520 (refer to FIG. 24) disposed to be spaced at a certain interval apart from the pin portion first connection terminal 510. The pin portion connection terminal first disposition portion 321 may include a pin portion first connection terminal first disposition portion 321a on which the pin portion first connection terminal 510 is disposed and a pin portion second connection terminal first disposition portion 321b on which the pin portion second connection terminal 520 (refer to FIG. 23) is disposed.

As described below, the first pin portion 450 or the second pin portion 460 may be fastened and electrically connected to the pin portion connection terminal 500.

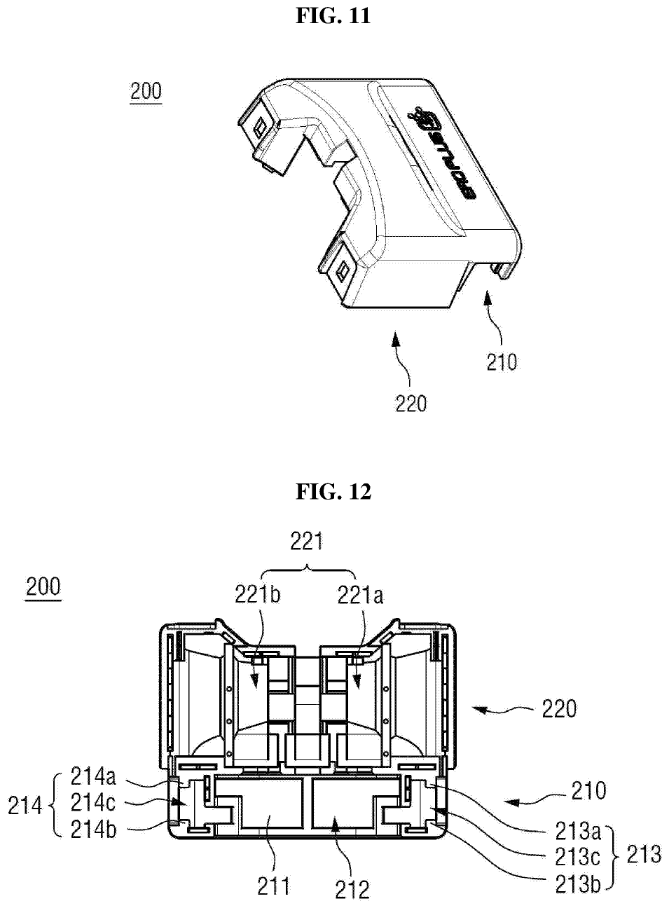

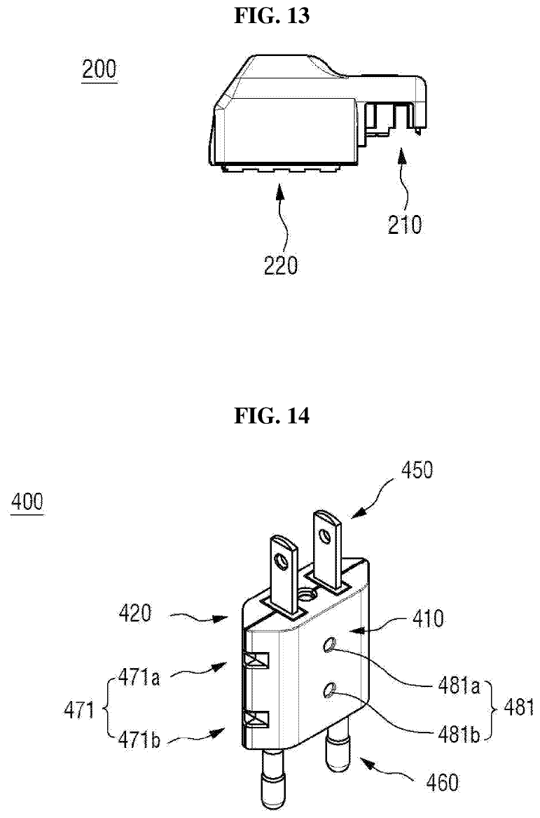

FIG. 11 is a perspective view illustrating the body plug portion cover portion according to the present invention, FIG. 12 is a plane view illustrating the body plug portion cover portion according to the present invention, and FIG. 13 is a side view illustrating the body plug portion cover portion according to the present invention. As described above, the body plug portion 200 and 300 of the plug 100 according to the present invention includes the body plug portion body portion 300, the body plug portion cover portion 200 which covers the body plug portion body portion 300, and the push portion 600 fastened to the side of the body plug portion body portion 300.

Here, the body plug portion cover portion 200 may be fastened to or separated from the body plug portion body portion 300. While the push portion 600 is fastened to the side of the body plug portion body portion 300, the body plug portion cover portion 200 may be fastened to the body plug portion body portion 300 so as to prevent the push portion 600 from being separated from the body plug portion body portion 300.

In more detail, referring to FIGS. 11 to 13, the body plug portion cover portion 200 includes a connection plug portion body portion second mounting portion 210, on which the connection plug portion body portion of the connection plug portion 400 is mounted, and a connection plug portion pin portion second connection portion 220 located consecutively with the connection plug portion body portion second mounting portion 210.

Here, the connection plug portion body portion second mounting portion 210 of the body plug portion cover portion 200 is located in an area corresponding to the connection plug portion body portion first mounting portion 310 of the body plug portion body portion 300. Also, the connection plug portion pin portion second connection portion 220 of the body plug portion cover portion 200 is located at a position in an area corresponding to the connection plug portion pin portion first connection portion 320 of the body plug portion body portion 300.

Accordingly, the connection plug portion body portion 410 and 420 is located in an area of the connection plug portion body portion mounting portion 210 and 310. Also, the first pin portion 450 or the second pin portion 460 is located in an area of the connection plug portion pin portion connection portion 220 and 320.

Subsequently, referring to FIGS. 11 to 13, the connection plug portion body portion second mounting portion 210 includes a second base plate 211 and a second space portion 212 formed above the second base plate 211. Here, the connection plug portion body portion 410 and 420 of the connection plug portion 400 may be mounted on the second space portion 212.

Meanwhile, as described above, the plug 100 according to the present invention includes the push portion 600 fastened to the side of the body plug portion body portion 300, and the push portion 600 includes the first push portion 610 fastened to the first side of the body plug portion body portion 300 and the second push portion 620 fastened to the second side of the body plug portion body portion 300.

Here, the connection plug portion body portion second mounting portion 210 includes a first push portion second fastening portion 213 located on a first side of the second base plate 211 and a second push portion second fastening portion 214 located on a second side of the second base plate 211. That is, the first push portion 610 is fastened to the first push portion second fastening portion 213, and the second push portion 620 is fastened to the second push portion second fastening portion 214.

In more detail, the first push portion second fastening portion 213 includes a 1-3 protruding portion 213a, a 1-4 protruding portion 213b disposed to be spaced at a certain interval apart from the 1-3 protruding portion 213a, and a 1-2 gap 213c according to the interval between the 1-3 protruding portion 213a and the 1-4 protruding portion 213b. The second push portion second fastening portion 214 includes a 2-3 protruding portion 214a, a 2-4 protruding portion 214b disposed to be spaced at a certain interval from the 2-3 protruding portion 214a, and a 2-2 gap 214c according to the interval between the 2-3 protruding portion 214a and the 2-4 protruding portion 214b.

That is, the first push portion 610 is fastened to the first push portion first fastening portion 313 and the first push portion second fastening portion 213, and the second push portion 620 is fastened to the second push portion first fastening portion 314 and the second push portion second fastening portion 214.

Subsequently, referring to FIGS. 11 to 13, the connection plug portion pin portion second connection portion 220 includes a pin portion connection terminal second disposition portion 221. The pin portion connection terminal second disposition portion 221 may include a pin portion first connection terminal second disposition 221a on which the pin portion first connection terminal 510 is disposed and a pin portion second connection terminal second disposition portion 221b on which the pin portion second connection terminal 520 is disposed.

Here, the pin portion first connection terminal first disposition portion 321a and the pin portion first connection terminal second disposition portion 221a may be located in corresponding areas. The pin portion second connection terminal first disposition portion 321b and the pin portion second connection terminal second disposition portion 221b may be located in corresponding areas. The pin portion first connection terminal may be disposed in an area of the pin portion first connection terminal disposition portions 321a and 221a, and the pin portion second connection terminal may be disposed in an area of the pin portion second connection terminal disposition portions 321b and 221b.

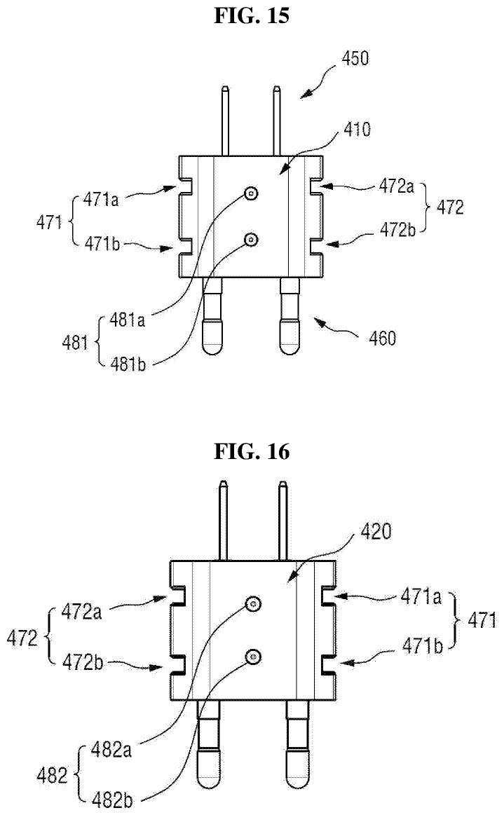

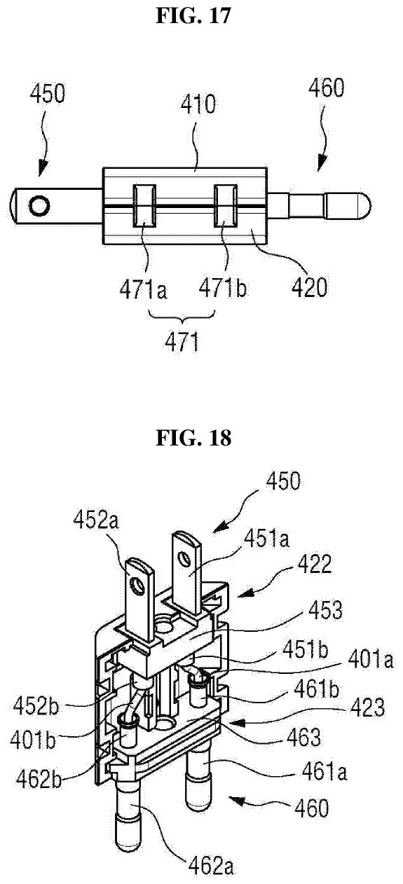

FIG. 14 is a perspective view illustrating the connection plug according to the present invention, FIG. 15 is a front view illustrating the connection plug according to the present invention, FIG. 16 is a rear view illustrating the connection plug according to the present invention, and FIG. 17 is a side view illustrating the connection plug according to the present invention.

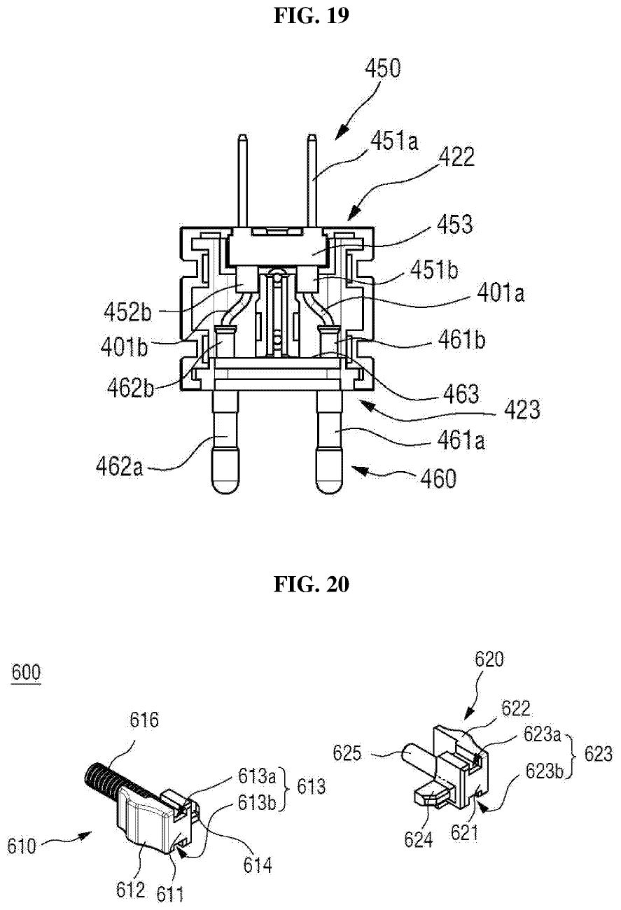

Also, FIG. 18 is a perspective view illustrating the connection plug according to the present invention excluding a first body portion, and FIG. 19 is a front view illustrating the connection plug according to the present invention excluding the first body portion.

That is, in FIGS. 18 and 19, for convenience of description, the connection plug portion is shown excluding the first body portion.

Referring to FIGS. 14 to 19, the connection plug 400 according to the present invention includes the connection plug body portion 410 and 420, the first pin portion 450 located on one side of the connection plug body portion 410 and 420, and the second pin portion 460 located on the other side of the connection plug body portion 410 and 420.

Here, the first pin portion 450 may be a pin portion for 110 V and the second pin portion 460 may be a pin portion for 220 V. However, the present invention does not restrict voltage ranges of the first pin portion 450 and the second pin portion 460.

Also, the connection plug body portion 410 and 420 includes a connection plug first body portion 410 and a connection plug second body portion 420 fastened to the connection plug first body portion 410.

That is, the connection plug first body portion 410 and the connection plug second body portion 420 are fastened to form the connection plug body portion 410 and 420.

Here, the connection plug body portion 410 and 420 includes a first pin portion fastening portion 422 located on one side and a second pin portion fastening portion 423 located on the other side. That is, the first pin portion 450 may be fastened to the first pin portion fastening portion 422 and the second pin portion 460 may be fastened to the second pin portion fastening portion 423.

Subsequently, referring to FIGS. 14 to 19, the first pin portion 450 includes a first pin portion fixing portion 453, 1-1 pins 451a and 451b fixed to one side of the first pin portion fixing portion 453, and 1-2 pins 452a and 452b fixed to the other side of the first pin portion fixing portion 453.

Here, the 1-1 pins 451a and 451b include one side 1-1 pin 451a located on one side of the first pin portion fixing portion 453 and the other side 1-1 pin 451b located on the other side of the first pin portion fixing portion 453. Also, the 1-2 pins 452a and 452b include one side 1-2 pin 452a located on one side of the first pin portion fixing portion 453 and the other side 1-2 pin 452b located on the other side of the first pin portion fixing portion 453.

Also, the second pin portion 460 includes a second pin portion fixing portion 463, 2-1 pins 461a and 461b fixed to one side of the second pin portion fixing portion 463, and 2-2 pins 462a and 462b fixed to the other side of the second pin portion fixing portion 463.

Here, the 2-1 pins 461a and 461b include one side 2-1 pin 461a located on one side of the second pin portion fixing portion 461 and the other side 2-1 pin 461b located on the other side of the second pin portion fixing portion 463. Also, the 2-2 pins 462a and 462b include one side 2-2 pin 462a located on one side of the second pin portion fixing portion 463 and the other side 2-2 pin 462b located on the other side of the second pin portion fixing portion 463.

Meanwhile, as shown in the drawings, the one side 1-1 pin 451a and the one side 1-2 pin 452a may protrude outward from the connection plug body portion 410 and 420 and be inserted into an electrical outlet, and the other side 1-1 pin 451b and the other side 1-2 pin 452b may be located inside the connection plug body portion 410 and 420.

Also, the one side 2-1 pin 461a and the one side 2-2 pin 462a may protrude outward from the connection plug body portion 410 and 420 and be inserted into an electrical outlet, and the other side 2-1 pin 461b and the other side 2-2 pin 462b may be located inside the connection plug body portion 410 and 420.

Also, the connection plug body portion 410 and 420 includes a first connection wire 401a, which connects the other side 1-1 pin 451b to the other side 2-1 pin 461b, and a second connection wire 401b which connects the other side 1-2 pin 452b to the other side 2-2 pin 462b. The other side 1-1 pin 451b and the other side 2-1 pin 461b may be electrically connected by the first connection wire 401a, and the other side 1-2 pin 452b and the other side 2-2 pin 462b may be electrically connected by the second connection wire 401b.

Subsequently, referring to FIGS. 14 to 19, the connection plug 400 according to the present invention includes a first slit portion 471 located on a first side surface of the connection plug body portion 410 and 420 and a second slit portion 472 located on a second side surface of the connection plug body portion 410 and 420.

In more detail, the first slit portion 471 includes a 1-1 slit 471a located on the first side surface of the connection plug body portion 410 and 420 to be adjacent to the first pin portion 450 and a 1-2 slit 471b located on the first side surface of the connection plug body portion 410 and 420 to be adjacent to the second pin portion 460. Also, the second slit portion 472 includes a 2-1 slit 472a located on the second side surface of the connection plug body portion 410 and 420 to be adjacent to the first pin portion 450 and a 2-2 slit 472b located on the second side surface of the connection plug body portion 410 and 420 to be adjacent to the second pin portion 460.

Here, although the number of slits of each of the first slit portion and the second slit portion is two in the drawings, in the present invention, one or more slits may be included and the number of the slits is not limited.

However, in the present invention, when the connection plug is coupled to the one side of the body plug portion 200 and 300, some components of the push portion have to be insertable into slits of the slit portion as described above. This will be described below.

Meanwhile, the slits according to the present invention are located on the first side surface of the connection plug body portion 410 and 420 or the second side surface of the connection plug body portion 410 and 420 while being continuously located from the connection plug first body portion 410 to the connection plug second body portion 420.

A configuration of the slit of the slit portion will be described below.

Subsequently, referring to FIGS. 14 to 19, the connection plug first body portion 410 according to the present invention includes a first fastening groove 481 located in a certain area of the connection plug first body portion 410, and the connection plug second body portion 420 according to the present invention includes a second fastening groove 482 located in a certain area of the connection plug second body portion 420.

As described above with reference to FIGS. 9 and 10, the connection plug portion body portion first mounting portion 310 includes the fastening hole 315 which is located in an area of the first space portion 312 of the first base plate 311 and passes through the first base plate 311.

Also, as described above, the electrical plug 100 according to the present invention includes the body plug portion 200 and 300 and the connection plug portion 400 attached to or detached from the one side of the body plug portion 200 and 300.

That is, the connection plug portion 400 according to the present invention is attached to or detached from the one side of the body plug portion 200 and 300. Accordingly, the connection plug portion 400 may be fastened to the body plug portion 200 and 300 or the connection plug portion 400 may be separated from the body plug portion 200 and 300.

Here, while the connection plug portion 400 is fastened to the one side of the body plug portion 200 and 300, the fastening hole 315 and the first fastening groove 481 may be fastened by fixing means so as to prevent the connection plug portion 400 from being arbitrarily separated from the one side of the body plug portion 200 and 300.

Also, on the other hand, while the connection plug portion 400 is fastened to the one side of the body plug portion 200 and 300, the fastening hole 315 and the second fastening groove 482 may be fastened by the fixing means so as to prevent the connection plug portion 400 from being arbitrarily separated from the one side of the body plug portion 200 and 300.

Here, the fixing means may be a well-known screw. That is, the fastening hole 315 and the first fastening groove 481 may be fixed or the fastening hole 315 and the second fastening groove 482 may be fixed by the screw so as to prevent the connection plug portion 400 from being arbitrarily separated from the one side of the body plug portion 200 and 300.

Meanwhile, when the screw passes through the connection plug first body portion 410, since the screw comes into contact with internal components of the connection plug portion 400 such that an electric shock accident occurs due to the screw, the screw should not pass through the connection plug first body portion 410, and thus, the first fastening groove 481 should be configured as a groove not a hole.

Due to the same reason, when the screw passes through the connection plug second body portion 420, since the screw comes into contact with internal components of the connection plug portion 400 such that an electric shock accident occurs due to the screw, the screw should not pass through the connection plug second body portion 420, and thus the second fastening groove 482 should be configured as a groove not a hole.

Subsequently, referring to FIGS. 14 to 19, the first fastening groove 481 includes a 1-1 fastening groove 481a located to be adjacent to the first pin portion 450 and a 1-2 fastening groove 481b disposed to be spaced at a certain interval from the 1-1 fastening groove 481a and located to be adjacent to the second pin portion 460.

Also, the second fastening groove 482 includes a 2-1 fastening groove 482a located to be adjacent to the first pin portion 450 and a 2-2 fastening groove 482b disposed to be spaced at a certain interval from the 2-1 fastening groove 482a and located to be adjacent to the second pin portion 460.

Here, although the number of grooves of each of the first fastening groove and the second fastening groove is two in the drawings, in the present invention, one or more grooves may be included and the number of such grooves is not limited.

However, in the present invention, when the connection plug is fastened to the one side of the body plug portion 200 and 300, the fastening hole 315 and the first fastening groove are located in corresponding areas and the fastening hole 315 and the second fastening groove are located in corresponding areas.

For example, as shown in the drawings, in a case that the number of grooves of each of the first fastening groove and the second fastening groove is two, when the first pin portion 450 of the connection plug portion 400 is inserted into the body plug portion 200 and 300, the fastening hole 315 and the 1-1 fastening groove 481a are located in corresponding areas or the fastening hole 315 and the 2-1 fastening groove 482a are located in corresponding areas.

Also, on the other hand, while the number of grooves of each of the first fastening groove and the second fastening groove is two, when the second pin portion 460 of the connection plug portion 400 is inserted into the body plug portion 200 and 300, the fastening hole 315 and the 1-2 fastening groove 481b are located in corresponding areas or the fastening hole 315 and the 2-2 fastening groove 482b are located in corresponding areas.

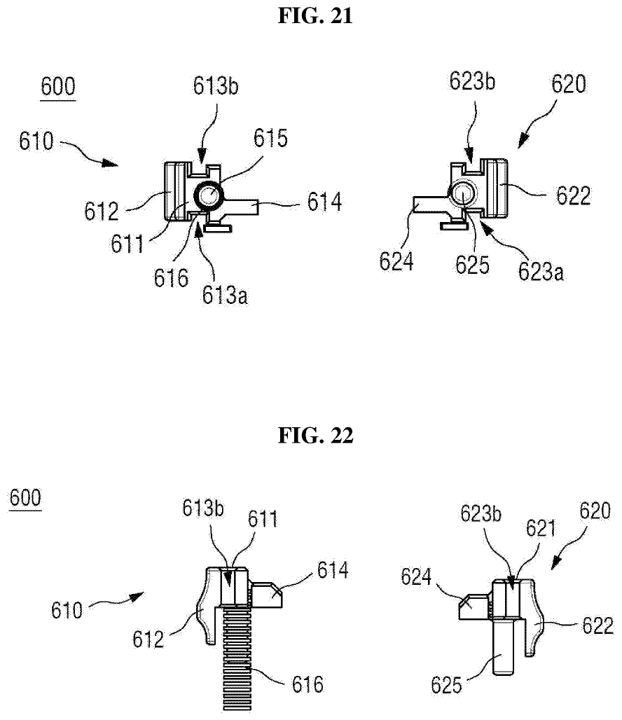

FIG. 20 is a perspective view illustrating the push portion according to the present invention, FIG. 21 is a bottom view illustrating the push portion according to the present invention, FIG. 22 is a front view illustrating the push portion according to the present invention, and FIG. 23 is a plane view illustrating the push portion according to the present invention.

Referring to FIGS. 20 to 23, the push portion 600 according to the present invention includes the first push portion 610 and the second push portion 620.

Meanwhile, as described above, the first push portion 610 is fastened to the first push portion first fastening portion 313 and the first push portion second fastening portion 213, and the second push portion 620 is fastened to the second push portion first fastening portion 314 and the second push portion second fastening portion 214.

In more detail, the first push portion 610 includes a first push portion body portion 611, a first push plate 612 located on an outer side surface of the first push portion body portion 611, a first concave portion 613 located on a rear surface and a front surface of the first push portion body portion 611, a first holding protruding portion 614 protruding from an inner side surface of the first push portion body portion 611, an elastic body first support portion 615 protruding from a bottom surface of the first push portion body portion 611, and a first elastic body 616 inserted into the elastic body first support portion 615.

Also, the second push portion 620 includes a second push portion body portion 621, a second push plate 622 located on an outer side surface of the second push portion body portion 621, a second concave portion 623 located on a rear surface and a front surface of the second push portion body portion 621, a second holding protruding portion 624 protruding from an inner side surface of the second push portion body portion 621, an elastic body second support portion 625 protruding from a bottom surface of the second push portion body portion 621, and a second elastic body (not shown) inserted into the elastic body second support portion 625.

Here, the first concave portion 613 includes a 1-1 concave portion 613a located on the rear surface of the first push portion body portion 611 and a 1-2 concave portion 613b located on the front surface of the first push portion body portion 611. The second concave portion 623 includes a 2-1 concave portion 623a located on the rear surface of the second push portion body portion 621 and a 2-2 concave portion 623b located on the front surface of the second push portion body portion 621.

As described above, the first push portion first fastening portion 313 includes the 1-1 protruding portion 313a, the 1-2 protruding portion 313b disposed to be spaced at a certain interval apart from the 1-1 protruding portion 313a, and the 1-1 gap 313c according to the interval between the 1-1 protruding portion 313a and the 1-2 protruding portion 313b. The second push portion first fastening portion 314 includes the 2-1 protruding portion 314a, the 2-2 protruding portion 314b disposed to be spaced at a certain interval from the 2-1 protruding portion 314a, and the 2-1 gap 314c according to the interval between the 2-1 protruding portion 314a and the 2-2 protruding portion 314b.

Also, as described above, the first push portion second fastening portion 213 includes the 1-3 protruding portion 213a, the 1-4 protruding portion 213b disposed to be spaced at a certain interval apart from the 1-3 protruding portion 213a, and the 1-2 gap 213c according to the interval between the 1-3 protruding portion 213a and the 1-4 protruding portion 213b. The second push portion second fastening portion 214 includes the 2-3 protruding portion 214a, the 2-4 protruding portion 214b disposed to be spaced at a certain interval from the 2-3 protruding portion 214a, and the 2-2 gap 214c according to the interval between the 2-3 protruding portion 214a and the 2-4 protruding portion 214b.

Here, the 1-1 protruding portion 313a of the first push portion first fastening portion 313 and the 1-3 protruding portion 213a of the first push portion second fastening portion 213 are inserted into the 1-1 concave portion 613a, and the 1-2 protruding portion 313b of the first push portion first fastening portion 313 and the 1-4 protruding portion 213b of the first push portion second fastening portion 213 are inserted into the 1-2 concave portion 613b such that the first push portion 610 may be fastened to the first push portion fastening portions 313 and 213.

Here, the 2-1 protruding portion 314a of the second push portion first fastening portion 314 and the 2-3 protruding portion 214a of the second push portion second fastening portion 214 are inserted into the 2-1 concave portion 623a, and the 2-2 protruding portion 314b of the second push portion first fastening portion 314 and the 2-4 protruding portion 214b of the second push portion second fastening portion 214 are inserted into the 2-2 concave portion 623b such that the second push portion 620 may be fastened to the second push portion fastening portions 314 and 214.

Meanwhile, as described above with reference to FIGS. 14 to 19, the connection plug 400 according to the present invention includes the first slit portion 471 located on the first side surface of the connection plug body portion 410 and 420 and the second slit portion 472 located on the second side surface of the connection plug body portion 410 and 420.

In more detail, the first slit portion 471 includes the 1-1 slit 471a located on the first side surface of the connection plug body portion 410 and 420 to be adjacent to the first pin portion 450 and the 1-2 slit 471b located on the first side surface of the connection plug body portion 410 and 420 to be adjacent to the second pin portion 460. Also, the second slit portion 472 includes the 2-1 slit 472a located on the second side surface of the connection plug body portion 410 and 420 to be adjacent to the first pin portion 450 and the 2-2 slit 472b located on the second side surface of the connection plug body portion 410 and 420 to be adjacent to the second pin portion 460.

Here, in the present invention, when the connection plug is fastened to the one side of the body plug portion 200 and 300, some components of the push portion have to be insertable into slits of the slit portion as described above.

In more detail, some component of the push portion, that is, the first holding protruding portion 614 of the first push portion 610 and the second holding protruding portion 624 of the second push portion 620, should be inserted into the slits of the slit portion.

For example, as shown in FIGS. 14 to 16, in a case in which the first slit portion 771 includes the 1-1 slit 471a and the 1-2 slit 471b and the second slit portion 772 includes the 2-1 slit 472a and the 2-2 slit 472b, when the first pin portion 450 of the connection plug portion 400 is inserted into the body plug portion 200 and 300, the first holding protruding portion 614 of the first push portion 610 should be inserted into the 1-1 slit 471a and the second holding protruding portion 624 of the second push portion 620 should be inserted into the 2-1 slit 472a or the first holding protruding portion 614 of the first push portion 610 should be inserted into the 2-1 slit 472a and the second holding protruding portion 624 of the second push portion 620 should be inserted into the 1-1 slit 471a.

Also, on the other hand, as shown in FIGS. 14 to 16, in a case in which the first slit portion 771 includes the 1-1 slit 471a and the 1-2 slit 471b and the second slit portion 772 includes the 2-1 slit 472a and the 2-2 slit 471b, when the second pin portion 460 of the connection plug portion 400 is inserted into the body plug portion 200 and 300, the first holding protruding portion 614 of the first push portion 610 should be inserted into the 1-2 slit 471b and the second holding protruding portion 624 of the second push portion 620 should be inserted into the 2-2 slit 472b or the first holding protruding portion 614 of the first push portion 610 should be inserted into the 2-2 slit 472b and the second holding protruding portion 624 of the second push portion 620 should be inserted into the 1-2 slit 471b.

Accordingly, when the first pin portion 450 of the connection plug portion 400 is inserted into the body plug portion 200 and 300 or the second pin portion 460 of the connection plug portion 400 is inserted into the body plug portion 200 and 300, it is possible to prevent the connection plug portion 400 from being separated from the body plug portion 200 and 300.

Meanwhile, in order to separate the connection plug portion 400 from the body plug portion 200 and 300, the above-described push plates, that is, the connection plug portion 400 may be separated from the body plug portion 200 and 300 by releasing a state in which the first holding protruding portion 614 of the first push portion 610 and the second holding protruding portion 624 of the second push portion 620 are inserted into the slits of the slit portion by pushing the first push plate 612 of the first push portion 610 and the second push plate 622 of the second push portion 620.

For example, on the basis of FIG. 22, the first holding protruding portion 614 of the first push portion 610 and the second holding protruding portion 624 of the second push portion 620 are moved downward by pushing the first push plate 612 of the first push portion 610 and the second push plate 622 of the second push portion 620 from an upward direction to a downward direction such that the state in which the first holding protruding portion 614 of the first push portion 610 and the second holding protruding portion 624 of the second push portion 620 are inserted into the slits of the slit portion may be released and then the connection plug portion 400 may be separated from the body plug portion 200 and 300.

Here, when the first push plate 612 of the first push portion 610 and the second push plate 622 of the second push portion 620 are pushed from the upward direction to the downward direction, the first elastic body 616 and the second elastic body are compressed. When a force of pushing the first push plate 612 of the first push portion 610 and the second push plate 622 of the second push portion 620 from the upward direction to the downward direction is eliminated, the compressed first elastic body 616 and the compressed second elastic body may return to original states and then the first push portion and the second push portion may return to initial positions.

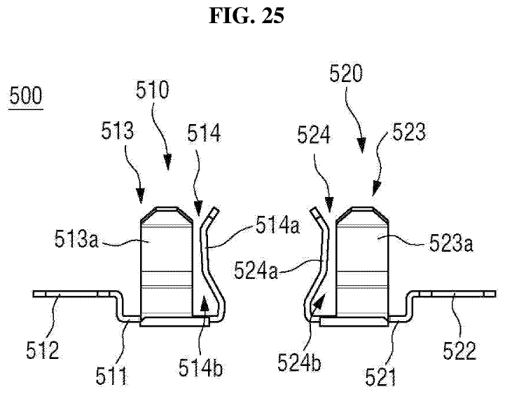

FIG. 24 is a perspective view illustrating the pin portion connection terminal according to the present invention, and FIG. 25 is a plane view illustrating the pin portion connection terminal according to the present invention.

Referring to FIGS. 24 and 25, as described above, the connection plug portion pin portion connection portion 320 (refer to FIG. 9) includes the pin portion connection terminal 500 and the pin portion connection terminal disposition portion 321 (refer to FIG. 9).

Here, the pin portion connection terminal 500 includes the pin portion first connection terminal 510 and the pin portion second connection terminal 520 disposed to be spaced at a certain interval apart from the pin portion first connection terminal 510. The pin portion connection terminal disposition portion 321 may include the pin portion first connection terminal disposition portion 321a on which the pin portion first connection terminal 510 is disposed and the pin portion second connection terminal disposition portion 321b on which the pin portion second connection terminal 520 is disposed.

In more detail with respect to the pin portion connection terminal 500, first, the pin portion first connection terminal 510 includes a first base terminal 511, a first fastening terminal 512 extending from a lateral surface of one side of the first base terminal 511 in a longitudinal direction, a first pin portion first insertion portion 514 located in a 1-1 area above the first base terminal 511, and a second pin portion first insertion portion 513 located in a 1-2 area above the first base terminal 511 to be adjacent to the first pin portion first insertion portion 514.

Here, the first fastening terminal 512 is connected to a wire or a circuit so that power may be finally applied to a product connected to the wire or the circuit.

Also, the first pin portion first insertion portion 514 includes a 1-1 plate 514a which extends from a lateral surface of the other side of the first base terminal 511 in the longitudinal direction and is located in a state of being bent from the first base terminal 511 at a certain angle.

Also, the second pin portion first insertion portion 513 includes a 1-2 plate 513a, which extends from a lateral surface of one side of the first base terminal 511 in a width direction and is located in a state of being bent from the first base terminal 511 at a certain angle and a 1-3 plate 513b which is disposed to face the 1-2 plate 513a, extends from a lateral surface of the other side of the first base terminal 511 in the width direction and is located in a state of being bent from the first base terminal 511 at a certain angle.

Here, the first pin portion first insertion portion 514 includes a first pin portion first insertion space 514b located between the 1-2 plate 513a, a side surface of the 1-3 plate 513b, and a plate surface of the 1-1 plate 514a. Also, the second pin portion first insertion portion 513 includes a second pin portion first insertion space 513c located between a plate surface of the 1-2 plate 513a and a plate surface of the 1-3 plate 513b.

Next, the pin portion second connection terminal 520 includes a second base terminal 521, a second fastening terminal 522 extending from a lateral surface of one side of the second base terminal 521 in a longitudinal direction, a first pin portion second insertion portion 524 located in a 2-1 area above the second base terminal 521, and a second pin portion second insertion portion 523 located in a 2-2 area above the second base terminal 521 to be adjacent to the first pin portion second insertion portion 524.

Here, the second fastening terminal 522 is connected to a wire or a circuit so that power may be eventually applied to a product connected to the wire or the circuit.

Also, the first pin portion second insertion portion 524 includes a 2-1 plate 524a which extends from a lateral surface of the other side of the second base terminal 521 in the longitudinal direction and is located in a state of being bent from the second base terminal 521 at a certain angle.

Also, the second pin portion second insertion portion 523 includes a 2-2 plate 523a, which extends from a lateral surface of one side of the second base terminal 521 in a width direction and is located in a state of being bent from the second base terminal 521 at a certain angle and a 2-3 plate 523b which is disposed to face the 2-2 plate 523a, extends from a lateral surface of the other side of the second base terminal 521 in the width direction and is located in a state of being bent from the second base terminal 521 at a certain angle.

Here, the first pin portion second insertion portion 524 includes a first pin portion second insertion space 524b located between the 2-2 plate 523a, a side surface of the 2-3 plate 523b, and a plate surface of the 2-1 plate 524a. Also, the second pin portion second insertion portion 523 includes a second pin portion second insertion space 523c located between a plate surface of the 2-2 plate 523a and a plate surface of the 2-3 plate 523b.

Meanwhile, the one side 1-1 pin 451a and the one side 1-2 pin 452a may protrude outward from the connection plug body portion 410 and 420 and be inserted into an electrical outlet. Also, the one side 2-1 pin 461a and the one side 2-2 pin 462a may protrude from the connection plug body portion 410 and 420 and be inserted into the electrical outlet.

Here, for example, when the one side 1-1 pin 451a and the one side 1-2 pin 452a are inserted into the electrical outlet, the one side 2-1 pin 461a and the one side 2-2 pin 462a are fastened to the pin portion connection terminal 500. In more detail, the one side 2-1 pin 461a is fastened to the second pin portion first insertion space 513c and the one side 2-2 pin 462a is fastened to the second pin portion second insertion space 523c.

Also, for example, when the one side 2-1 pin 461a and the one side 2-2 pin 462a are inserted into the electrical outlet, the one side 1-1 pin 451a and the one side 1-2 pin 452a are fastened to the pin portion connection terminal 500. In more detail, the one side 1-1 pin 451a is fastened to the first pin portion first insertion space 514b and the one side 1-2 pin 452a is fastened to the first pin portion second insertion space 524b.

Accordingly, when the one side 1-1 pin 451a and the one side 1-2 pin 452a are inserted into the electrical outlet, power transferred to the one side 2-1 pin 461a and the one side 2-2 pin 462a is transferred to the pin portion connection terminal 500. The pin portion connection terminal is connected to a wire or a circuit such that the power may be finally applied to a product connected to the wire or the circuit.

Also, on the other hand, when the one side 2-1 pin 461a and the one side 2-2 pin 462a are inserted into the electrical outlet, power transferred to the one side 1-1 pin 451a and the one side 1-2 pin 452a is transferred to the pin portion connection terminal 500. The pin portion connection terminal is connected to a wire or a circuit such that the power may be finally applied to a product connected to the wire or the circuit.

As described above, the one side 1-1 pin 451a and the one side 1-2 pin 452a may protrude outward from the connection plug body portion 410 and 420 and be inserted into the electrical outlet. Also, the one side 2-1 pin 461a and the one side 2-2 pin 462a may protrude from the connection plug body portion 410 and 420 and be inserted into the electrical outlet.

For example, when the one side 1-1 pin 451a and the one side 1-2 pin 452a are inserted into the electrical outlet, the one side 1-1 pin 451a and the one side 1-2 pin 452a receive power from the electrical outlet. The power applied to the one side 1-1 pin 451a and the one side 1-2 pin 452a may be transferred to the one side 2-1 pin 461a and the one side 2-2 pin 462a.

Also, the power transferred to the one side 2-1 pin 461a and the one side 2-2 pin 462a is transferred to the pin portion connection terminal and the pin portion connection terminal is connected to a wire or a circuit so that the power may be finally applied to a product connected to the wire or the circuit.

Also, on the other hand, for example, when the one side 2-1 pin 461a and the one side 2-2 pin 462a are inserted into the electrical outlet, the one side 2-1 pin 461a and the one side 2-2 pin 462a receive power from the electrical outlet. The power applied to the one side 2-1 pin 461a and the one side 2-2 pin 462a may be transferred to the one side 1-1 pin 451a and the one side 1-2 pin 452a.

Also, the power transferred to the one side 1-1 pin 451a and the one side 1-2 pin 452a is transferred to the pin portion connection terminal and the pin portion connection terminal is connected to a wire or a circuit so that the power may be finally applied to a product connected to the wire or the circuit.

Accordingly, in the present invention, since whether the second pin portion of the connection plug is inserted into an electrical outlet or the first pin portion of the connection plug is inserted into the electrical outlet varies depending on whether the first pin portion is inserted into the body plug portion or the second pin portion is inserted into the body plug portion, a plug for a combined use which is applicable to a variety of electrical outlets having different forms may be provided.

Although the embodiments of the present invention have been described above with reference to the attached drawings, it can be understood by one of ordinary skill in the art that the present invention may include other detailed forms without departing from the technical concept or essential features thereof. Therefore, it should be understood that the above-described embodiments are exemplary and not limitative in every aspect.

1. A connection plug comprising:
a connection plug body portion;
a first pin portion located on one side of the connection plug body portion;
a second pin portion located on the other side of the connection plug body portion;
a first slit portion located on a first side surface of the connection plug body portion; and
a second slit portion located on a second side surface of the connection plug body portion,
wherein the connection plug body portion comprises a connection plug first body portion and a connection plug second body portion fastened to the connection plug first body portion, and
wherein the connection plug body portion comprises a first fastening groove located in a certain area of the connection plug first body portion and a second fastening groove located in a certain area of the connection plug second body portion.

2. The connection plug of claim 1, wherein the first fastening groove comprises a 1-1 fastening groove located to be adjacent to the first pin portion and a 1-2 fastening groove disposed to be spaced at a certain interval apart from the 1-1 fastening groove and located to be adjacent to the second pin portion, and the second fastening groove comprises a 2-1 fastening groove located to be adjacent to the first pin portion and a 2-2 fastening groove disposed to be spaced at a certain interval apart from the 2-1 fastening groove and located to be adjacent to the second pin portion, and
wherein the first slit portion comprises a 1-1 slit located to be adjacent to the first pin portion and a 1-2 slit located to be adjacent to the second pin portion, and the second slit portion comprises a 2-1 slit located to be adjacent to the first pin portion and a 2-2 slit located to be adjacent to the second pin portion.

3. A plug comprising:
a body plug portion;
a connection plug portion attached to or detached from one side of the body plug portion; and
a push portion fastened to a lateral surface of the body plug portion,
wherein the body plug portion comprises a body plug portion body portion and a body plug portion cover portion which covers the body plug portion body portion,
wherein the body plug portion body portion comprises a connection plug portion body portion first mounting portion on which the connection plug portion body portion of the connection plug portion is mounted, and
wherein the connection plug portion body portion first mounting portion comprises a first base plate, a first space portion formed above the first base plate, and a fastening hole which is located in an area of the first space portion and passes through the first base plate.

4. The plug of claim 3, wherein the connection plug comprises a connection plug body portion, a first pin portion located on one side of the connection plug body portion, a second pin portion located on the other side of the connection plug body portion, a first slit portion located on a first side surface of the connection plug body portion, and a second slit portion located on a second side surface of the connection plug body portion, and
wherein the connection plug body portion comprises a connection plug first body portion and a connection plug second body portion fastened to the connection plug first body portion and comprises a first fastening groove located in a certain area of the connection plug first body portion and a second fastening groove located in a certain area of the connection plug second body portion.

5. The plug of claim 4, wherein the first fastening groove comprises a 1-1 fastening groove located to be adjacent to the first pin portion and a 1-2 fastening groove disposed to be spaced at a certain interval apart from the 1-1 fastening groove and located to be adjacent to the second pin portion, the second fastening groove comprises a 2-1 fastening groove located to be adjacent to the first pin portion and a 2-2 fastening groove disposed to be spaced at a certain interval apart from the 2-1 fastening groove and located to be adjacent to the second pin portion, the first slit portion comprises a 1-1 slit located to be adjacent to the first pin portion and a 1-2 slit located to be adjacent to the second pin portion, and the second slit portion comprises a 2-1 slit located to be adjacent to the first pin portion and a 2-2 slit located to be adjacent to the second pin portion.

6. The plug of claim 4, wherein while the connection plug portion is fastened to one side of the body plug portion, the fastening hole and the first fastening groove are fastened using fixing means, or while the connection plug portion is fastened to the one side of the body plug portion, the fastening hole and the second fastening groove are fastened using the fixing means.

7. The plug of claim 5, wherein when the first pin portion is inserted into the body plug portion, the fastening hole and the 1-1 fastening groove are located in corresponding areas or the fastening hole and the 2-1 fastening groove are located in corresponding areas, and
wherein when the second pin portion is inserted into the body plug portion, the fastening hole and the 1-2 fastening groove are located in corresponding areas or the fastening hole and the 2-2 fastening groove are located in corresponding areas.

8. The plug of claim 5, wherein the push portion comprises a first push portion fastened to a first side of the body plug portion body portion and a second push portion fastened to a second side of the body plug portion body portion,
wherein the connection plug portion body portion first mounting portion comprises a first push portion first fastening portion located on a first side of the first base plate and a second push portion first fastening portion located on a second side of the first base plate,
wherein the first push portion comprises a first push portion body portion, a first push plate located on an outer side surface of the first push portion body portion, a first concave portion located on a rear surface and a front surface of the first push portion body portion, a first holding protruding portion protruding from an inner side surface of the first push portion body portion, an elastic body first support portion protruding from a bottom surface of the first push portion body portion, and a first elastic body inserted into the elastic body first support portion,
wherein the second push portion comprises a second push portion body portion, a second push plate located on an outer side surface of the second push portion body portion, a second concave portion located on a rear surface and a front surface of the second push portion body portion, a second holding protruding portion protruding from an inner side surface of the second push portion body portion, an elastic body second support portion protruding from a bottom surface of the second push portion body portion, and a second elastic body inserted into the elastic body second support portion, and
wherein the first concave portion comprises a 1-1 concave portion located on the rear surface of the first push portion body portion and a 1-2 concave portion located on the front surface of the first push portion body portion, and the second concave portion comprises a 2-1 concave portion located on the rear surface of the second push portion body portion and a 2-2 concave portion located on the front surface of the second push portion body portion.

9. The plug of claim 8, wherein when the first pin portion is inserted into the body plug portion, the first holding protruding portion is inserted into the 1-1 slit and the second holding protruding portion is inserted into the 2-1 slit or the first holding protruding portion is inserted into the 2-1 slit and the second holding protruding portion is inserted into the 1-1 slit, and
wherein when the second pin portion is inserted into the body plug portion, the first holding protruding portion is inserted into the 1-2 slit and the second holding protruding portion is inserted into the 2-2 slit or the first holding protruding portion is inserted into the 2-2 slit and the second holding protruding portion is inserted into the 1-2 slit.

10. The plug of claim 4, wherein the body plug portion body portion comprises a connection plug portion pin portion first connection portion located consecutively with the connection plug portion body portion first mounting portion,
wherein the connection plug portion pin portion first connection portion comprises a pin portion connection terminal,
wherein the pin portion connection terminal comprises a pin portion first connection terminal and a pin portion second connection terminal disposed to be spaced at a certain interval apart from the pin portion first connection terminal,
wherein the pin portion first connection terminal comprises a first base terminal, a first fastening terminal extending from a side surface of one side of the first base terminal in a longitudinal direction, a first pin portion first insertion portion located in a 1-1 area above the first base terminal, and a second pin portion first insertion portion located in a 1-2 area above the first base terminal to be adjacent to the first pin portion first insertion portion,
wherein the first pin portion first insertion portion comprises a 1-1 plate extending from a side surface of the other side of the first base terminal in the longitudinal direction and located in a state of being bent from the first base terminal at a certain angle, and the second pin portion first insertion portion comprises a 1-2 plate extending from a side surface of one side of the first base terminal in a width direction and located in a state of being bent from the first base terminal at a certain angle and a 1-3 plate which is disposed to face the 1-2 plate, extends from a side surface of the other side of the first base terminal in the width direction, and is located in a state of being bent from the first base terminal at a certain angle,
wherein the first pin portion first insertion portion comprises a first pin portion first insertion space located between the 1-2 plate, a side surface of the 1-3 plate, and a plate surface of the 1-1 plate, and the second pin portion first insertion portion comprises a second pin portion first insertion space located between a plate surface of the 1-2 plate and a plate surface of the 1-3 plate,
wherein the pin portion second connection terminal comprises a second base terminal, a second fastening terminal extending from a side surface of one side of the second base terminal in a longitudinal direction, a first pin portion second insertion portion located in a 2-1 area above the second base terminal, and a second pin portion second insertion portion located in a 2-2 area above the second base terminal to be adjacent to the first pin portion second insertion portion,
wherein the first pin portion second insertion portion comprises a 2-1 plate extending from a side surface of the other side of the second base terminal in the longitudinal direction and located in a state of being bent from the second base terminal at a certain angle, and the second pin portion second insertion portion comprises a 2-2 plate extending from a side surface of one side of the second base terminal in a width direction and located in a state of being bent from the second base terminal at a certain angle and a 2-3 plate which is disposed to face the 2-2 plate, extends from a side surface of the other side of the second base terminal in the width direction, and is located in a state of being bent from the second base terminal at a certain angle, and
wherein the first pin portion second insertion portion comprises a first pin portion second insertion space located between the 2-2 plate, a side surface of the 2-3 plate, and a plate surface of the 2-1 plate, and the second pin portion second insertion portion comprises a second pin portion second insertion space located between a plate surface of the 2-2 plate and a plate surface of the 2-3 plate.
